(19) United States
(12) Patent Application Publication
(10) Pub. No.: US 2012/0046987 A1
(43) Pub. Date: Feb. 23, 2012

(54) Mobile Paint Matching Service

(76) Inventor: Ronald Lee, Cave Creek, AZ (US)

(21) Appl. No.: 12/859,200

(22) Filed: Aug. 18, 2010

(51) Int. Cl. G06Q 10/00; G01J 3/40

(52) U.S. Cl. 705/7.21; 356/402

(57) ABSTRACT

A mobile paint matching service employs at least one vehicle to perform on-site color matching. The vehicle is equipped with at least one portable spectrophotometer; a paint analysis system to determine recommended paint formulas; a plurality of spill-resistant containers, including containers holding a paint component (including paint bases and a variety of colorants) and others that are empty; and a paint mixer. A computerized scheduling system is used to schedule the vehicle for arrival at a plurality of job sites. At each job site, the color characteristics of painted surfaces are obtained using the portable spectrophotometer. Preferably, a recommended paint formula is determined using the paint analysis system based at least in part on averaging several different spectrophotometer readings. The paint mixer is used to mix selected paint components according to a specified paint formula. The customer can then purchase the paint to be used on the job directly at the job site after testing it to ensure that it matches.

### FIELD OF THE INVENTION

The present invention relates to a system and method for providing a mobile paint matching service.

### BACKGROUND

One of the greatest problems in the painting and restoration industries involves the time consuming nature of paint color matching. On average, it takes approximately 2-3 hours for a paint match at a typical home improvement or hardware store. Indeed, some paint centers take an entire day to match paint and have it ready for their customers. Additional time will be spent if the color is applied and found not to match. In this case, the process of paint matching essentially starts all over again. That is, the customer will have to again visit the retail location.

Consider the cost to a contractor who pays an hourly rate of $25 to workers. If it takes two man-hours per visit to a paint matching center, the per-visit cost will be $50. In the case of a job requiring an additional visit, the cost will be $100 total just in labor. Also, because paint matching services do not guarantee their services, the paint purchased in the first attempt will be wasted. Assuming a gallon of paint costs $25, the contractor will accrue an additional $25, bringing the total cost to the contractor to $125 just for paint matching.

Accordingly, it would be desirable for there to be an alternative approach to the conventional paint matching business model that is more efficient and less time consuming.

### SUMMARY OF THE INVENTION

As an alternative to the conventional paint matching business model, a mobile paint matching service is provided. The mobile paint matching service employs at least one vehicle to perform on-site color matching. The vehicle is equipped with at least one portable spectrophotometer; a paint analysis system to determine recommended paint formulas; a plurality of spill-resistant containers, including containers holding a paint component (including paint bases and a variety of colorants) and others that are empty; and a paint mixer. A computerized scheduling system is used to schedule the vehicle for arrival at a plurality of job sites. At each job site, the color characteristics of painted surfaces are obtained using the portable spectrophotometer. Preferably, a recommended paint formula is determined using the paint analysis system based at least in part on averaging several different spectrophotometer readings. The paint mixer is used to mix selected paint components according to a specified paint formula. The customer can then purchase the paint to be used on the job directly at the job site after testing it to ensure that it matches.

According to preferred embodiments of the present invention, the computerized scheduling system includes information about each of the jobs that are scheduled, including one or more of a job site address, a schedule date, a service length, a contact name, and a lockbox code (if a lockbox is to be used). Preferably, the computerized scheduling system sends an automated email notification to each customer after a job has been completed.

According to preferred embodiments of the present invention, the paint analysis system can allow for manual input of additional characteristics of the paint to be matched. These can include lighting conditions (e.g., daylight lighting, incandescent lighting, and fluorescent lighting) of the paint sample, whether the paint is oil-based or latex-based, paint sheen (e.g., flat, satin, semi-gloss, or gloss), etc. Preferably, the recommended paint formula can be adjusted to accommodate user preference. Advantageously, this can be done at the job site at the customer's discretion.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows an exemplary mobile unit equipped with necessary instruments, supplies and equipment for providing a mobile paint matching service, according to a preferred embodiment of the present invention;

FIG. 2 shows an exemplary left wall layout of the cargo area of the mobile unit;

FIG. 3 shows an exemplary right wall layout of the cargo area of the mobile unit;

FIG. 4 shows an exterior view of the exemplary mobile unit; and

FIG. 5 shows a work flow diagram of an exemplary method for providing the mobile paint color matching service.

### DETAILED DESCRIPTION

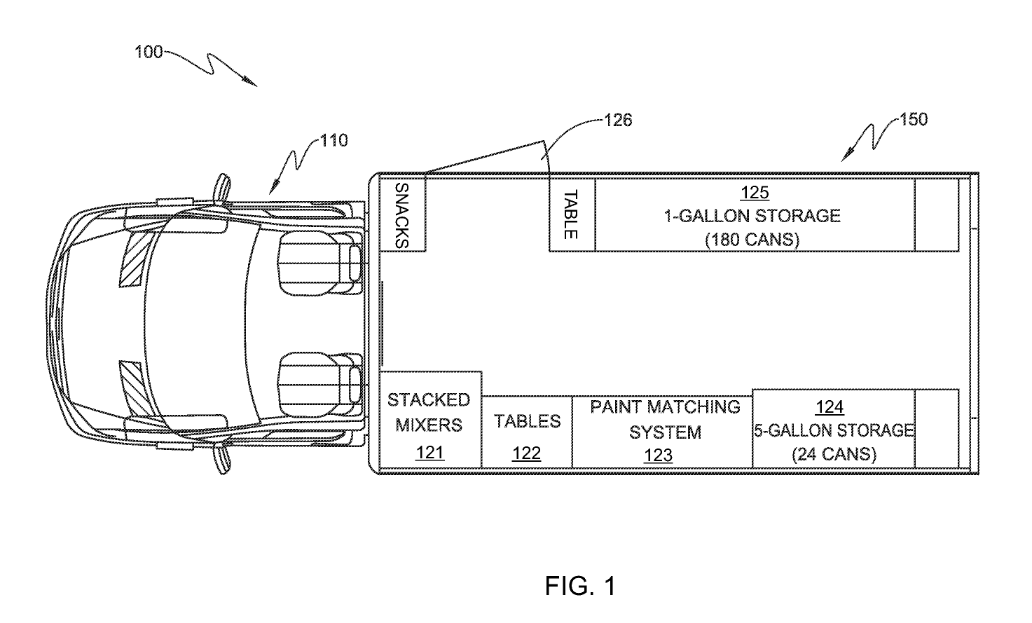

FIG. 1 illustrates an exemplary mobile unit 100 equipped with instruments, supplies and equipment for providing a mobile paint matching service, according to a preferred embodiment of the present invention. As shown, the mobile unit 100 can be a box truck, such as, for example, the Mercedes-Benz Sprinter with a custom box, or similar commercial model. In general, the mobile vehicle 100 chosen for the mobile paint matching service should be sufficiently spacious to accommodate the instruments, supplies and equipment needed to service on-site paint matching for at least one day without running out of supplies. Preferably, the mobile unit 100 will include an air conditioning and heating unit and a generator to supply electricity needed to run the instruments and equipment. Preferably, the generator will be capable of generating at least 5 kw of electricity, though generators capable of generating less may suffice.

If a box truck is chosen, the mobile unit 100 will include a separate cab 110 and a cargo area 150 (as shown) (otherwise, the cargo area 150 will probably not be a separable part of the vehicle). As shown in FIG. 1, an exemplary layout of cargo area 150 is provided. The exemplary layout includes areas for placement of a plurality of 5-gallon storage containers 124 (preferably, at least 24 cans), a plurality of 1-gallon storage containers 125 (preferably, at least 180 cans), stacked mixers 121, tables 122, and a paint matching system 123. Preferably, the cargo area 150 will include access via a door, such as door 126, as shown. Additionally, the cargo area 150 can include other areas for snacks, tables, fire extinguisher, credit card system, etc.

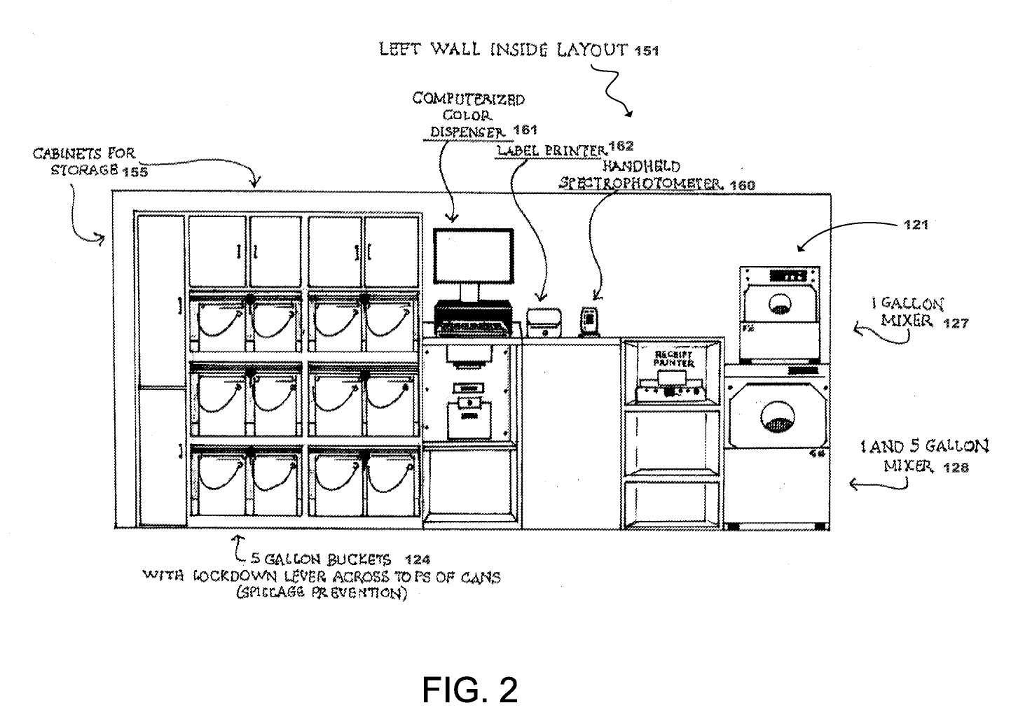

FIG. 2 shows an exemplary left wall layout 151 of the cargo area 150. As illustrated, the left wall layout 151 includes space for a plurality of cabinets 155 preferably built into the wall, the storage area for placement of the 5-gallon storage containers 124, the paint matching system 123 (including a handheld spectrophotometer 160, a computerized color dispenser 161, and a label printer 162), and the stacked mixers 121 (including a 1-gallon mixer 127 stacked atop a 1- and 5-gallon mixer 128).

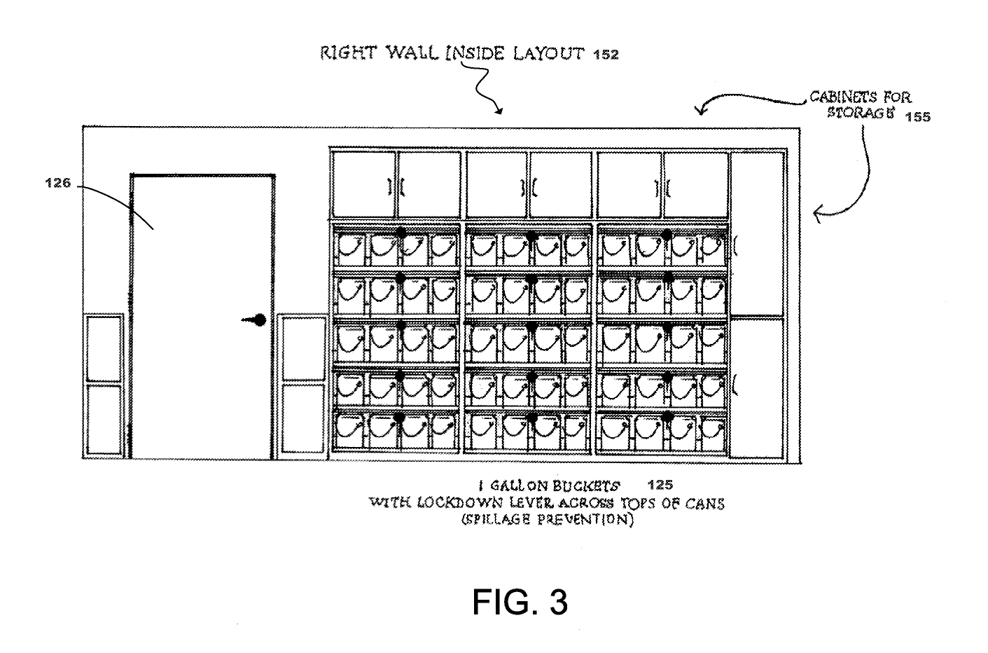

FIG. 3 shows an exemplary right wall layout 152 of the cargo area 150. As shown, the right wall layout 152 includes the door 126 to allow entry into the mobile unit 100. Additionally, the right wall layout 152 includes cabinets 155 preferably built into the wall, and the storage area for placement of 1-gallon storage containers 125.

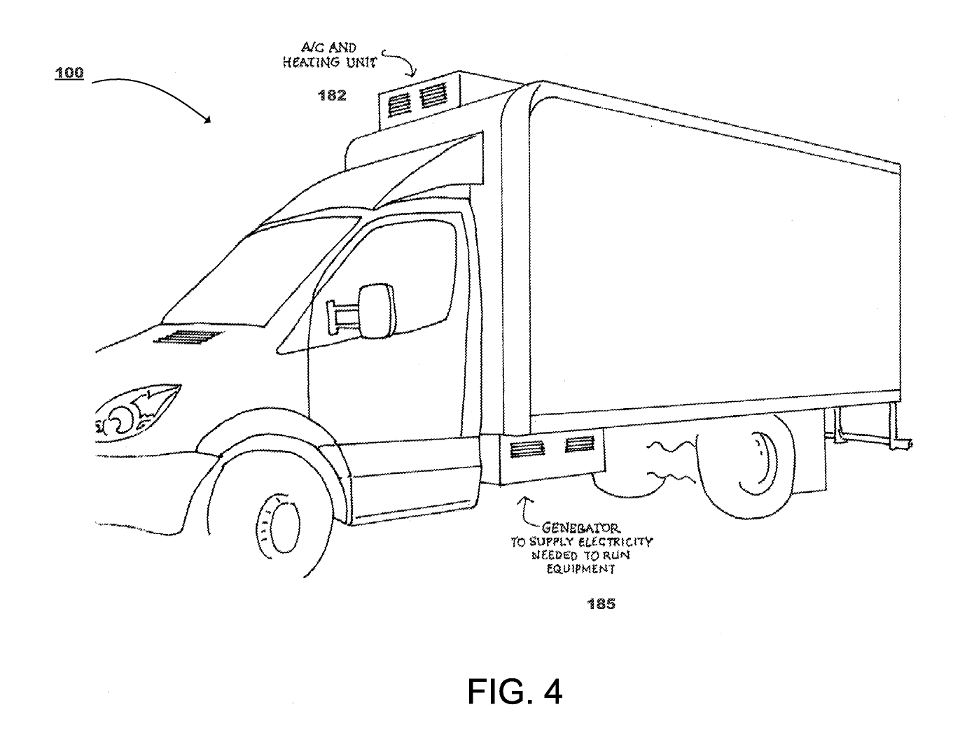

FIG. 4 shows an exterior view of the exemplary mobile unit 100.

Preferably, the handheld spectrophotometer 160 will be a lightweight device that can be carried with a technician at the work site and be operable with the computerized color dispenser 161 to seamlessly provide accurate results.

Representative portable instruments to determine characteristics of a paint sample useable in conjunction with the present invention include various portable spectrophotometers made by X-rite Corporation, Grand Rapids, Michigan. Preferably, the computerized color dispenser 161 includes a computer system having installed software to perform color analysis and matching and to output a recommended paint formula. Typical hardware requirements for the computer system include at least one computer with at least an INTEL PENTIUM III processor; at least 1 GB RAM; 500 MB to 2 GB available disc space; and a suitable operating system installed, such as LINUX, or WINDOWS 2000, XP, or Vista by Microsoft Corporation. Representative hardware that may be used in conjunction with the software of the present invention includes the DIMENSION line of servers by Dell, Inc. Representative systems usable to perform color analysis and matching include the MATCHRITE and X50 series by X-Rite Corporation. Preferably, the label printer 162 will be capable of printing paint can labels. Suitable printers for such purpose include the LABELWRITER SE300 label printer by DYMO Corporation (Newell Rubbermaid).

Although the exemplary floor plan layouts 151, 152 described above depict a specific arrangement, it is to be appreciated that this is provided for illustrative purposes only, and is not meant to be limiting. For example, depending on the size of the cargo area 150 chosen, the number of storage containers might have to be different from the number shown. Furthermore, care should be taken to ensure that the mobile vehicle 100 is not over-weighted on either side of the cargo area 150. In such a case, the floor plan layout would have to modified so as to balance the vehicle load.

Furthermore, it is to be understood that various additional equipment, such as a desktop spectrophotometer, can be included. Furthermore, because of the vast amount of paint colors and types of paint that exist, only paint from a particular manufacturer (and of a particular quality level) may be included. Moreover, not every conceivable type of sheen or tint can be included due to space and cost constraints.

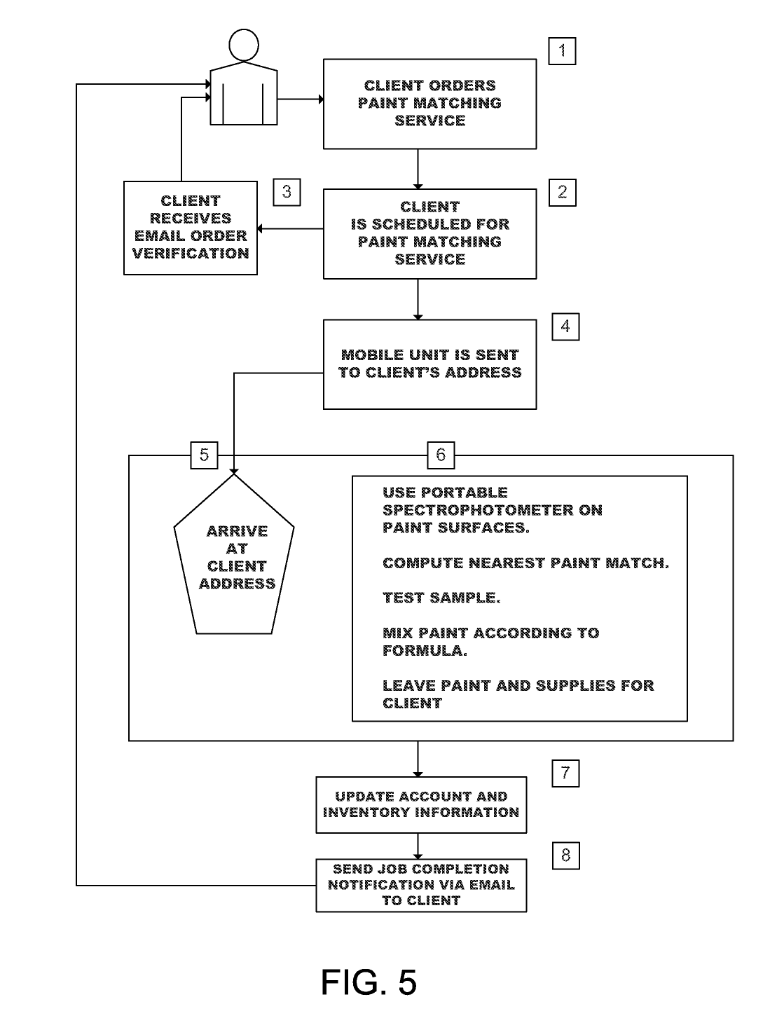

FIG. 5 shows a work flow diagram of an exemplary method for providing the mobile paint color matching service.

Initially, in Step 1, a client orders the paint matching service. Preferably, the client order can be placed either via telephone or a Web site. For telephone orders, either a live operator can take the order or it can be taken automatically by an interactive voice response (IVR) system. Once an order is taken, a client account is set up (for new clients) or reference is made to an existing client account (for repeat clients). A job order is then generated with information collected from the client, including, preferably, the client's contact information (e.g., name, address, telephone number), the rooms to be color matched, an amount and type of paint for each of the rooms, and a date when the work is desired. In the case of an order using a Web site, the above information can be input by the client into one or more forms, for example. In the case of a phone order using a live operator, the same information can be inputted by the operator. If the order is taken by the IVR, the information can be taken by the IVR system either via a touchtone phone by the client or using voice recognition, or a combination of both. The account information and job order can be stored in a relational database.

Next, in Step 2, the client is scheduled for the paint matching service. Such scheduling can involve estimating an amount of time to do the job and searching for an available block of available time. Representative scheduling software usable for this purpose includes the SERVICECEO software provided by Insight Direct, Boston, Massachusetts. Such software will preferably also be capable of arranging schedules so that work sites that are physically close by are scheduled together, if practical. Various reports can also be produced showing scheduled jobs during a specified period (e.g., daily, weekly, monthly).

In Step 3, the client receives email notification verifying the order was placed, including work order details and scheduled arrival date and estimated arrival time.

In Step 4, the mobile unit 100 arrives at the client address. At the client address, in Step 5, the technician performs various tasks to provide the color matching service, including:

using the handheld spectrophotometer 160 to take several readings (preferably 3-4) directly from each painted surface in the affected room;

taking the handheld spectrophotometer 160 to the mobile unit 100 and connecting it to the paint matching system 123;

using the paint matching system 123 to compute a recommended paint formula from an average of the readings, which may also involve manually inputting paint and environmental characteristics, such as lighting condition (e.g., daylight lighting, incandescent lighting, and fluorescent lighting), whether the paint is oil-based or latex-based, the paint sheen (e.g., flat, satin, semi-gloss, or gloss), and a preferred brand and/or quality level, etc.;

mixing a sample of paint according to the recommended paint formula outputted by the paint matching system 123;

testing the paint sample directly on the affected paint surface to determine if it matches;

if the paint matches, using a paint mixer, mixing a quantity of the paint according to the formula outputted by the paint matching system 123 (otherwise, making an adjustment to the test sample, then re-applying the paint sample to the affected area); and

leaving a specified quantity of the mixed paint and painting supplies (if desired) for the client.

In Step 6, upon completion of the scheduled job, the client's account and billing information are adjusted to reflect job completion. In Step 7, an e-mail notification is automatically generated and sent to the client.

A notable feature of the present invention is the ability to take multiple spectrophotometer readings at the jobsite on the affected surfaces to be re-painted. In contrast, conventionally, a small sample of a wall or other surface must be taken to a retail location which may be handled by a worker with soiled hands and in an environment different for the actual one where the paint will be applied.

Another notable feature of the present invention is the ability to deal with fading issues. Let's say that one wall was damaged and repaired. To ensure a good match, the paint on an adjacent, undamaged wall can be color matched since that is the wall that is going to be seen next to freshly painted wall later. Currently, this cannot generally be done because a paint sample from the undamaged wall will not usually be available.

Another notable feature of the present invention is the color formula can be saved for later use.

Another notable feature of the present invention is that the software of the invention can be tied from an office computer to an onboard computer for ease of accessing all information at any time. It can also be tied into a credit card payment center for cash customers to pay at point of sale situations.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for providing a mobile paint matching service, the mobile paint matching service employing at least one vehicle to perform on-site color matching and paint mixing, comprising:
(a) using at least one computer system to schedule the vehicle for arrival at a plurality of job sites;
(b) equipping the vehicle with:
(i) a portable instrument to determine characteristics of a paint sample;
(ii) a paint analysis system to determine a recommended paint formula;
(iii) a plurality of containers, each container holding a paint component; and
(iv) a paint mixer; and
(c) at each of the job sites,
(i) determining characteristics of a paint sample of at least one painted surface at the job site using the portable instrument;
(ii) determining a recommended paint formula using the paint analysis system based at least in part on the determined characteristics of the paint sample; and
(iv) mixing selected paint components according to the recommended paint formula to arrive at a quantity of paint substantially similar in appearance to the paint sample.

2. The method of claim 1, wherein the at least one portable instrument to determine characteristics of a paint sample includes at least one portable spectrophotometer.

3. The method of claim 1, wherein the computer system to schedule the vehicle for arrival at a plurality of job sites calculates an estimated quantity of paint components to load onto the vehicle to service all of the scheduled customers.

4. The method of claim 1, wherein the paint components include both paint bases and colorants.

5. The method of claim 1, wherein the recommended paint formula includes a recommendation as to a quantity of a base and quantities of at least one colorant.

6. The method of claim 1, wherein the portable instrument to determine characteristics of a paint sample can be calibrated at the job site.

7. The method of claim 1, wherein the paint sample includes an averaged paint sample, the averaged paint sample derived from a plurality of paint samples taken from various surfaces at the job site.

8. The method of claim 1, wherein the computer system to schedule the vehicle for arrival at a plurality of job sites includes one or more of a job site address, a date, a service length, a detailed description of the areas needing paint matching, a contact name, and a lockbox code.

9. The method of claim 1, wherein determining the recommended paint formula further includes manually inputting additional characteristics and basing the recommended formula at least in part on the manually inputted characteristics along with the characteristics of the paint sample determined by the portable instrument.

10. The method of claim 9, wherein the manually input characteristics includes lighting condition.

11. The method of claim 10, wherein the lighting condition includes daylight lighting, incandescent lighting, and fluorescent lighting.

12. The method of claim 9, wherein the manually input characteristics includes whether the paint is oil-based or latex-based.

13. The method of claim 9, wherein the manually input characteristics includes paint sheen.

14. The method of claim 13, wherein the paint sheen includes flat, satin, semi-gloss, or gloss.

15. The method of claim 9, wherein the manually input characteristics includes a specified paint base.

16. The method of claim 1, further including the step of adjusting the recommended formula.

17. The method of claim 1, further including the step of emailing the customer with an indication that the job has completed.

18. The method of claim 1, wherein the vehicle is further equipped with a generator.

19. A vehicle to be used in a mobile paint matching service employing at least one vehicle to perform on-site color matching and paint mixing, comprising:
a motorized vehicle having a cargo area, the cargo area equipped with:
(a) a portable spectrophotometer to determine characteristics of a paint sample;
(b) a paint analysis system to determine a recommended paint formula;
(c) a plurality of containers, each container holding a paint component; and
(d) a paint mixer.

20. A method for providing a mobile paint matching service, the mobile paint matching service employing the vehicle of claim 19 to perform on-site color matching and paint mixing, comprising
at each of a plurality of sites,
(a) determining characteristics of a paint sample of at least one painted surface at the job site using the portable instrument;
(b) determining a recommended paint formula using the paint analysis system based at least in part on the determined characteristics of the paint sample; and
(c) mixing selected paint components according to the recommended paint formula to arrive at a quantity of paint substantially similar in appearance to the paint sample.
